(19) United States
(12) Patent Application Publication
(10) Pub. No.: US 2026/0228615 A1
(43) Pub. Date: Aug. 6, 2026

(54) Visualization-Based Anomaly Detection for Predictive Maintenance

(71) Applicant: Disney Enterprises, Inc., Burbank, CA (US)

(72) Inventors: Amber E. Paulsen, Burbank, CA (US); Sarah Pagano, Burbank, CA (US); Jeremy Eaton, Burbank, CA (US)

(21) Appl. No.: 19/047,498

(22) Filed: Feb. 6, 2025

(51) Int. Cl. G06N 20/00

(52) U.S. Cl. CPC G06N 20/00

(57) ABSTRACT

A system includes a hardware processor and a memory storing software code and a trained machine learning (ML) model. The hardware processor is configured to execute the software code to receive data describing an operation by an apparatus, generate, using the data, a first visual representation of the operation, and predict, using the trained ML model and the first visual representation, whether an operating state of the apparatus during the operation is anomalous. When predicting identifies an anomalous operating state by the apparatus, the hardware processor is further configured to execute the software code to obtain a second visual representation of an expected operation by the apparatus during a normal operating state of the apparatus, perform a comparison of the first visual representation with the second visual representation, and output an alert including a result of the comparison of the first visual representation with the second visual representation.

### BACKGROUND

Many industrial apparatuses are interconnected systems-of-systems having designs that are increasingly complicated and are susceptible to malfunction or failure for many different reasons. The larger a system-of-systems based apparatus is, the more difficult, costly and inefficient it can become to identify and troubleshoot the sources of anomalous apparatus operation. Conventional solutions for anticipating apparatus malfunctions and failures have relied upon the deep knowledge base of highly experienced system engineers, which, due to the heavy reliance of those solutions on the expertise of particular individuals, are brittle and ultimately untenable. Consequently, there is a need in the art for a solution enabling system engineers of varying degrees of experience to readily diagnose the operational states of complex apparatuses, and to accurately anticipate situations in which those system are likely to malfunction or fail.

### BRIEF DESCRIPTION OF THE DRAWINGS

FIG. 1 shows an exemplary system providing visualization-based anomaly detection for predictive maintenance, according to one implementation;

FIG. 2 shows a more detailed diagram of the portable device shown in FIG. 1, according to one implementation;

FIG. 3A shows an exemplary visual representation, in the form of a bitmap, of the expected operation of an apparatus, according to one implementation;

FIG. 3B shows an exemplary visual representation, in the form of a bitmap, of the actual operation by the apparatus represented in FIG. 3A, according to one implementation;

FIG. 3C shows an exemplary visual representation, in the form of a bitmap, comparing the visual representation shown in FIG. 3B with the visual representation shown in FIG. 3A, according to one implementation;

FIG. 3D shows an exemplary visual representation, in the form of a pixel map, of the operation of an apparatus, according to another implementation; and

FIG. 4 shows a flowchart presenting an exemplary method providing visualization-based anomaly detection for predictive maintenance, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As stated above, many industrial apparatuses are interconnected systems-of-systems having designs that are increasingly complicated and are susceptible to malfunction or failure for many different reasons. The larger a system-of-systems based apparatus is, the more difficult, costly and inefficient it can become to identify and troubleshoot the sources of anomalous apparatus operation. Conventional solutions for anticipating apparatus malfunctions and failures have relied upon the deep knowledge base of highly experienced system engineers, which, due to the heavy reliance of those solutions on the expertise of particular individuals, are brittle and ultimately untenable.

The present application discloses systems and methods providing visualization-based anomaly detection for predictive maintenance that address and overcome the drawbacks and deficiencies in the conventional art by enabling system engineers of varying degrees of experience to readily diagnose the operational states of complex apparatuses, and to accurately anticipate situations in which those system are likely to malfunction or fail. The present solution recognizes that even complex apparatuses are designed to follow an expected operating pattern that is programmed. Sensors may be outfitted on, in, or adjacent to apparatus components that allow for these operating patterns to be tracked through data. The present visualization-based anomaly detection for predictive maintenance solution advances the state-of-the-art by converting sensor readings or other data describing an operation by an apparatus into a visual representation of that operation, such as a bitmap image or pixel map image, for example. This novel and inventive transformation of the data advantageously enables use of one or more sophisticated visualization-based machine learning (ML) models to trained to predict whether the apparatus is operating normally or in an anomalous operating state indicative of malfunction, future apparatus failure, or both. Furthermore, training the visualization-based anomaly detection ML model(s) advantageously allows for training as few as a single ML model having the ability to predict many different types of malfunctions and failures of a particular apparatus.

It is noted that due to the complexity of the apparatuses for which visualization-based anomaly detection for predictive maintenance is provided by the systems and methods disclosed herein, i.e., the number and interrelatedness of the components and subsystems comprised by each apparatus, reliance upon a trained ML model to accurately predict anomalous operation is essential. Thus, due to the complexity of the operation of the apparatuses subject to the present predictive maintenance solution, the present proactively predictive method is incapable of being performed as a mental process by a human mind, even with the aid of a general purpose computer. That is to say, while conventional attempts to predict anomalous operation by complex apparatuses may result in such predictions lagging the generation of operational data by hours, days or weeks, or even being performed as a diagnosis rather than prediction, in a forensic process post hoc to malfunction or failure of the system, the present ML model-based solution improves the technical field of mechanical troubleshooting and maintenance by advantageously enabling corrective interventions in real-time before apparatus failures or significant malfunctions occur. For example, an alert predicting anomalous operation by an apparatus may be output by the present system and according to the present method within up to ten seconds of receipt by the system of operational data for the apparatus, while a corrective intervention may be initiated within seconds or minutes of outputting the alert.

The outputs provide by the systems and using the methods disclosed in the present application can be used to produce simple, interpretable visualizations that will easily identify where and when the operation of components of an apparatus are deviating from expectations. Additionally, a bitmap or pixel map of normal apparatus component behavior can be overlaid with a bitmap or pixel map of a present operating state of the apparatus to show exactly which components are behaving differently, and at what time during apparatus operation that component behavior change occurs. Moreover, it is noted that in some implementations, the present visualization-based anomaly detection for predictive maintenance solution may advantageously be implemented as automated systems and methods. As used in the present application, the terms “automation,” “automated” and “automating” refer to systems and processes that do not require the participation of a human system operator. Thus, the methods described in the present application may be performed under the control of hardware processing components of the disclosed systems.

It is also noted that, as defined in the present application, the expression “ML model” refers to a computational model for making predictions based on patterns learned from samples of data or training data. Various learning algorithms can be used to map correlations between input data and output data. These correlations form the computational model and can be used to make future predictions on new input data. Such a predictive model may include one or more logistic regression models, Bayesian models, artificial neural networks (NNs) such as Transformers, large-language models (LLMs), or multimodal foundation models, to name a few examples. In various implementations, ML models may be trained as classifiers and may be utilized to perform image processing, audio processing, natural-language processing, and other inferential analyses. A “deep neural network,” in the context of deep learning, may refer to a NN that utilizes multiple hidden layers between input and output layers, which may allow for learning based on features not explicitly defined in raw data. As used in the present application, a feature identified as a NN refers to a deep neural network.

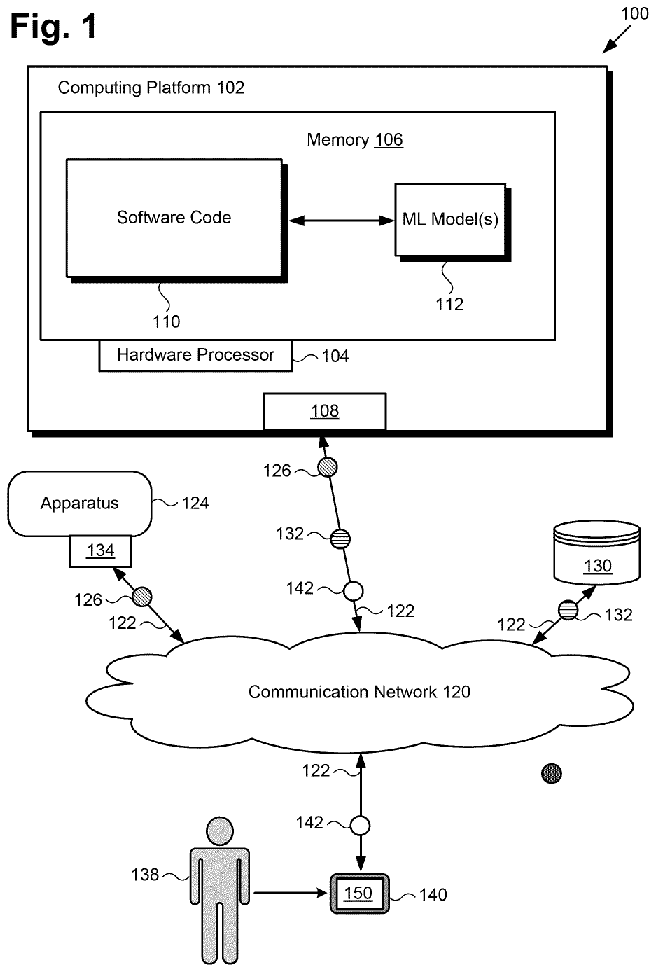

FIG. 1 shows exemplary system 100 providing visualization-based anomaly detection for predictive maintenance, according to one implementation. As shown in FIG. 1, system 100 includes computing platform 102 having hardware processor 104, memory 106 implemented as a computer-readable non-transitory storage medium, and transceiver 108. According to the present exemplary implementation, memory 106 stores software code 110 and one or more trained ML models 112 (hereinafter “trained ML model(s) 112”). In some implementations, trained ML model(s) may include one or more NNs, such as U-Nets for example.

As further shown in FIG. 1, system 100 is implemented within a use environment including apparatus 124, one or more sensors 134 (hereinafter “sensor(s) 134”), apparatus expected operational state database 130 storing visual representations of expected operations by apparatus 124 during a normal operating state of apparatus 124, portable device 140 including display 150, and communication network 120 providing network communication links 122 communicatively coupling system 100 with apparatus 124, apparatus expected operational state database 130, and portable device 140. Also shown in FIG. 1 is system user 138 utilizing portable device 140 to interact with system 100, as well as data 126 describing an operation by apparatus 124, visual representation 132 of the expected operation by apparatus 124 during a normal operating state of apparatus 124, and alert 142 output by system 100.

It is noted that system user 138 may be an engineer or programmer tasked with evaluating the operational performance of apparatus 124. It is further noted that, in some use cases, data 126 may describe a past operation of apparatus 124, and may be utilized to perform a forensic analysis of a historical performance of apparatus 124. However, in other use cases, data 126 may be received dynamically while apparatus 124 is in operation. In some implementations, as shown in FIG. 1, data 126 may be received from sensor(s) 134 via communication network 120 and network communication links 122. It is also noted that in various implementations, apparatus 124 may be or include a baggage claim carousel, an automated warehouse, a theme park attraction, a vehicle assembly line machine, an aviation system, a HVAC system, an engine, a manufacturing equipment, or a computer server, to name a few examples.

Sensor(s) 134 may include one or more sensors affixed to apparatus 124, internal to apparatus 124, or situated adjacent to apparatus 124 within a venue housing apparatus 124. Sensor(s) 134 may include one or more cameras, one or more audio microphones, one or more temperature sensors, one or more pressure sensors, one or more vibration sensors, one or more chemical sensors, one or more timing devices, or any combination thereof. Sensor(s) 134 may be configured to detect one or more of visual images, sounds, vibrations, heat, pressure, time duration, air quality or smells (aromas).

Although the present application refers to software code 110 and trained ML model(s) 112 as being stored in memory 106 for conceptual clarity, more generally, memory 106 may take the form of any computer-readable non-transitory storage medium. The expression “computer-readable non-transitory storage medium,” as defined in the present application, refers to any medium, excluding a carrier wave or other transitory signal, that provides instructions to hardware processor 104 of computing platform 102. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, internal and external hard drives, optical discs, RAM, programmable read-only memory (PROM), erasable PROM (EPROM) and FLASH memory.

Moreover, in some implementations, system 100 may utilize a decentralized secure digital ledger in addition to memory 106. Examples of such decentralized secure digital ledgers may include a blockchain, hashgraph, directed acyclic graph (DAG), and Holochain® ledger, to name a few. In use cases in which the decentralized secure digital ledger is a blockchain ledger, it may be advantageous or desirable for the decentralized secure digital ledger to utilize a consensus mechanism having a proof-of-stake (PoS) protocol, rather than the more energy intensive proof-of-work (PoW) protocol.

It is further noted that although FIG. 1 depicts software code 110 and trained ML model(s) 112 as being stored together in a single instance of memory 106, that representation is merely provided as an aid to conceptual clarity. More generally, system 100 may include one or more computing platforms 102, such as computer servers for example, which may be co-located, or may form an interactively linked but distributed system, such as a cloud-based system, for instance. As a result, hardware processor 104 and memory 106 may correspond to distributed processor and memory resources within system 100. Furthermore, although FIG. 1 depicts apparatus expected operational state database 130 as a remote resource accessible by system 100 via communication network 120 and network communication links 122, in some implementations, apparatus expected operational state database 130 may be a component of system 100 and may be stored within memory 106.

Hardware processor 104 may include a plurality of hardware processing units, such as one or more central processing units, one or more graphics processing units, and one or more tensor processing units, one or more field-programmable gate arrays (FPGAs), custom hardware for machine-learning training or inferencing, and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving programs, such as software code 110, from memory 106, while a GPU may be implemented to reduce the processing overhead of the CPU by performing computationally intensive graphics or other processing tasks. A TPU is an application-specific integrated circuit (ASIC) configured specifically for artificial intelligence (AI) applications such as ML modeling.

Transceiver 108 of system 100 may be implemented as a wireless communication unit configured for use with one or more of a variety of wireless communication protocols. For example, transceiver 108 may include a fourth generation (4G) wireless transceiver and/or a 5G wireless transceiver. In addition, or alternatively, transceiver 108 may be configured for communications using one or more of Wireless Fidelity (Wi-Fi®), Worldwide Interoperability for Microwave Access (WiMAX®), Bluetooth®, Bluetooth® low energy (BLE), ZigBee®, radio-frequency identification (RFID), near-field communication (NFC), and 60 GHz wireless communications methods.

In some implementations, computing platform 102 may correspond to one or more web servers, accessible over a packet-switched network such as the Internet, for example. Alternatively, computing platform 102 may correspond to one or more computer servers supporting a private wide area network (WAN), local area network (LAN), or included in another type of limited distribution or private network. In addition, or alternatively, in some implementations, system 100 may utilize a local area broadcast method, such as User Datagram Protocol (UDP) or Bluetooth®, for instance. Furthermore, in some implementations, system 100 may be implemented virtually, such as in a data center. For example, in some implementations, system 100 may be implemented in software, or as virtual machines. Moreover, in some implementations, communication network 120 may be a high-speed network suitable for high performance computing (HPC), for example a 10 GigE network or an Infiniband network.

Portable device 140 may take the form of a smartphone, or any other suitable portable computing system that implements data processing capabilities sufficient to provide a user interface, and implement the functionality attributed to portable device 140 herein. For example, in other implementations, portable device 140 may take the form of a tablet computer, laptop computer, or an augmented reality (AR) or virtual reality (VR) device, for example, providing display 150. Display 150 may take the form of a liquid crystal display (LCD), a light-emitting diode (LED) display, an organic light-emitting diode (OLED) display, a quantum dot (QD) display, or any other suitable display screen that performs a physical transformation of signals to light.

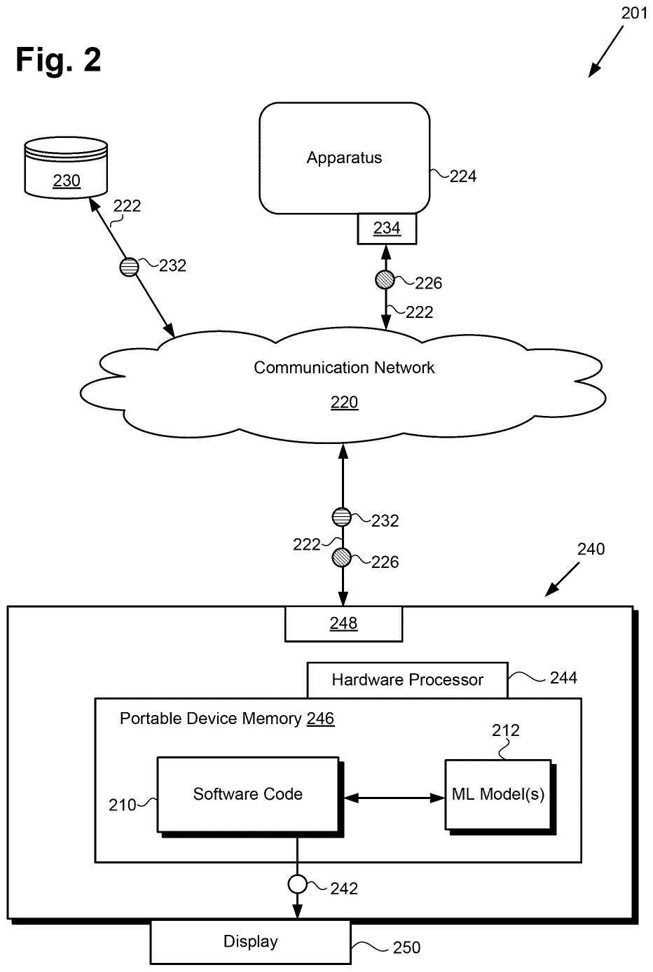

FIG. 2 shows a more detailed diagram of portable device 240, according to one implementation. As shown in FIG. 2, portable device 240 includes hardware processor 244, transceiver 248, display 250, and portable device memory 246 implemented as a computer-readable non-transitory storage medium storing software code 210 and one or more trained ML models 212 (hereinafter “trained ML model(s) 212”).

As further shown in FIG. 2, portable device 240 is utilized in use environment 201 including apparatus 224, one or more sensors 234 (hereinafter “sensor(s) 234”), apparatus expected operational state database 230 and communication network 220 providing network communication links 222 communicatively coupling portable device 240 with apparatus 224 and apparatus expected operational state database 230. Also shown in FIG. 2 are data 226 describing an operation by apparatus 224, visual representation 232 of the expected operation by apparatus 224 during a normal operating state of apparatus 224 and alert 242 displayed by portable device 240.

Apparatus 224, sensor(s) 234 apparatus expected operational state database 230 and communication network 220 providing network communication links 222 correspond respectively in general to apparatus 124, sensor(s) 134, apparatus expected operational state database 130 and communication network 120 providing network communication links 122, in FIG. 1. Consequently, apparatus 224, sensor(s) 234, apparatus expected operational state database 230 and communication network 220 providing network communication links 222 may share any of the characteristics attributed to respective apparatus 124, sensor(s) 134, apparatus expected operational state database 130 and communication network 120 providing network communication links 122, and vice versa. That is to say, in various implementations, like apparatus 124, apparatus 224 may be or include a baggage claim carousel, an automated warehouse, a theme park attraction, a vehicle assembly line machine, an aviation system, a HVAC system, an engine, a manufacturing equipment, or a computer server, to name a few examples, while sensor(s) 234 may include one or more sensors affixed to apparatus 224, internal to apparatus 224, or situated adjacent to apparatus 224 within a venue housing apparatus 224. Moreover, like sensor(s) 134, sensor(s) 234 may include one or more cameras, one or more audio microphones, one or more temperature sensors, one or more pressure sensors, one or more vibration sensors, one or more chemical sensors, one or more timing devices, or any combination thereof.

In addition, data 226, visual representation 232 and alert 242, in FIG. 2, correspond respectively in general to data 126, visual representation 132 and alert 142, in FIG. 1. As a result, data 226, visual representation 232 and alert 242 may share any of the characteristics attributed to respective data 126, visual representation 132 and alert 142 by the present disclosure, and vice versa.

Portable device 240 and display 250 correspond respectively in general to portable device 140 and display 150, in FIG. 1. Thus, portable device 240 and display 250 may share any of the characteristics attributed to respective portable device 140 and display 150 by the present disclosure, and vice versa. For example, like portable device 140, portable device 240 may take the form of a smartphone, tablet computer, laptop computer, or an AR or VR device, for example, providing display 250. In addition, like display 150, display 250 may take the form of an LCD, LED display, OLED display, or QD display. Moreover, although not shown in FIG. 1, portable device 140 may include features corresponding respectively to hardware processor 244, transceiver 248 and portable device memory 246 storing software code 210 and trained ML model(s) 212.

Transceiver 248 may be implemented as a wireless communication unit configured for use with one or more of a variety of wireless communication protocols. For example, transceiver 248 may include a 4G wireless transceiver and/or a 5G wireless transceiver. In addition, or alternatively, transceiver 248 may be configured for communications using one or more of Wi-Fi®, WiMAX®, Bluetooth®, BLE, ZigBee®, RFID, NFC, and 60 GHz wireless communications methods.

Hardware processor 244 of portable device 240 may include multiple hardware processing units, such as one or more CPUs, one or more GPUs, one or more TPUs, and one or more FPGAs, as those features are defined above.

Software code 210 and trained ML model(s) 212 correspond respectively in general to software code 110 and trained ML model(s) 112, in FIG. 1, and can perform all of the operations attributed to those corresponding features by the present disclosure. In other words, in implementations in which hardware processor 244 of portable device 240 executes software code 210 stored locally in portable device memory 246, portable device 240 may perform any of the actions attributed to system 100 by the present disclosure. Thus, in some implementations, system 100 may be embodied in portable device 140/240.

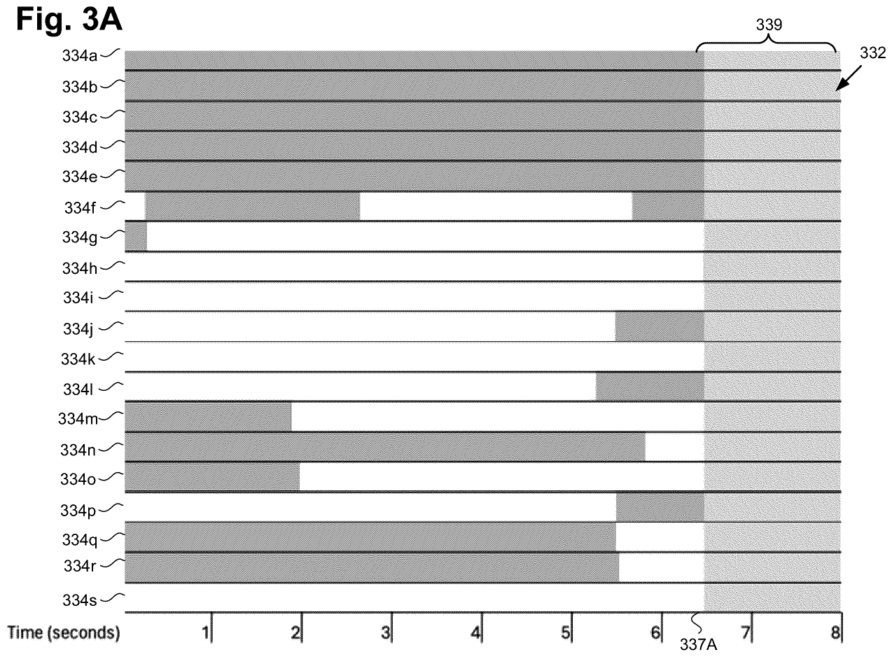

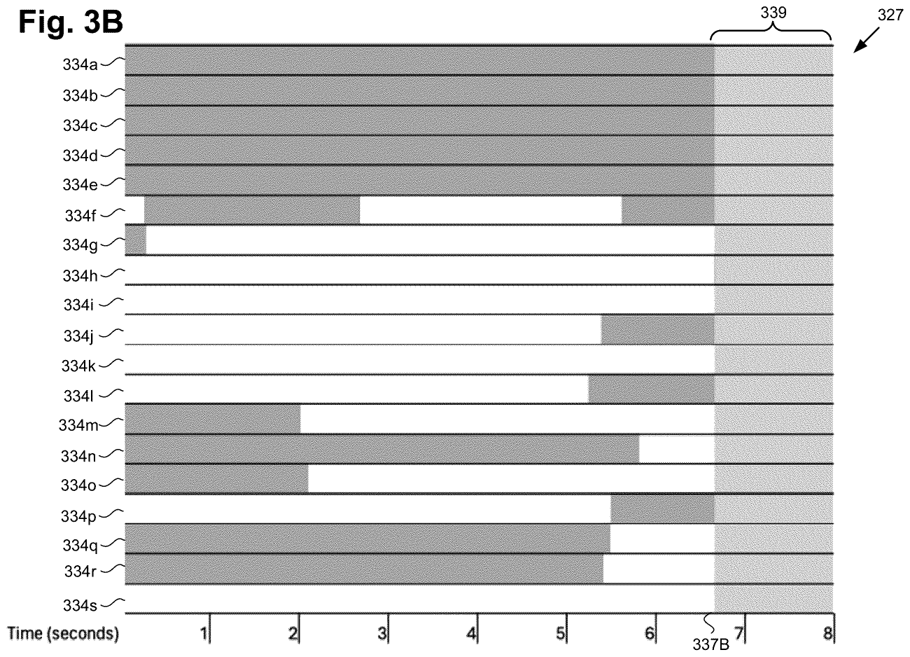

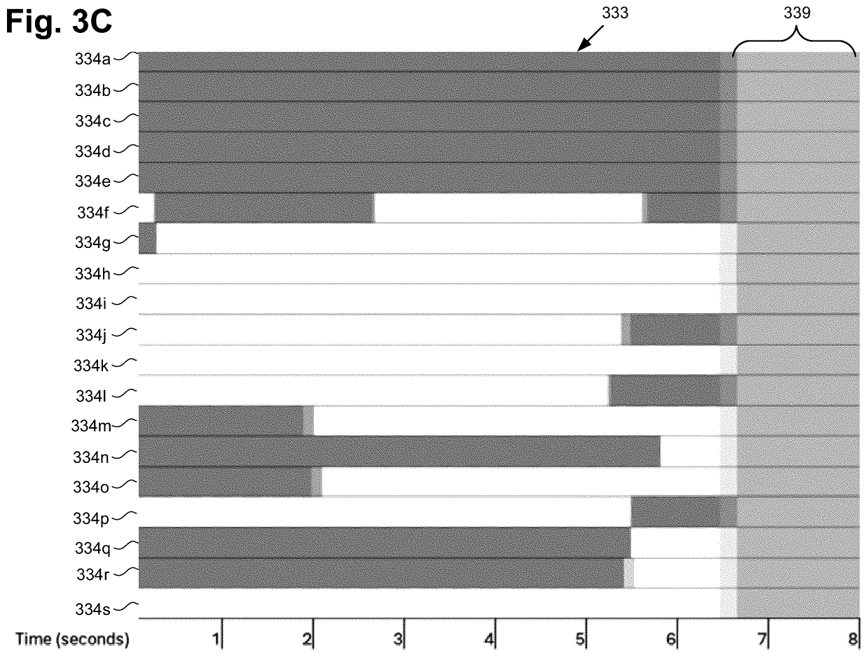

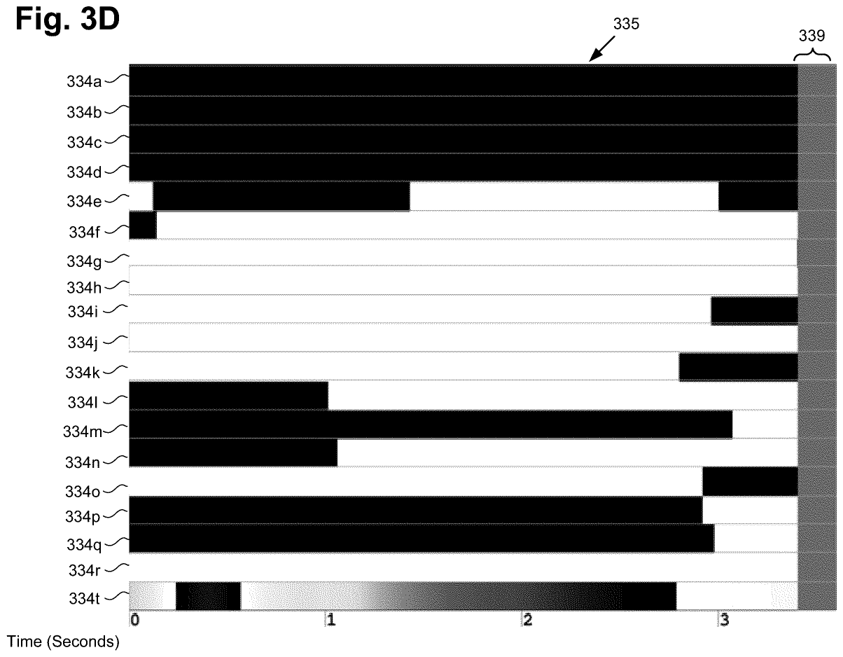

FIG. 3A shows exemplary visual representation 332, in the form of a bitmap, of the expected operation of apparatus 124/224, according to one implementation. Visual representation 332 corresponds in general to visual representation 132/232 in FIGS. 1 and 2. Accordingly, visual representation 332 may share any of the characteristics attributed to visual representation 132/232 by the present disclosure, and vice versa. It is noted that although visual representation 123/232/332 depicts the expected operation of apparatus 124/224 under normal operating conditions, visual representation 132/232/332 does not necessarily depict a single operation by apparatus 124/224, but may instead be produced based on an aggregate performance of the same operation a plurality of times by apparatus 124/224 when apparatus 124/224 is in a normal operating state. Thus, in some implementations visual representation 132/232/332 may depict a single “most ideal” operation by apparatus 124/224, while in other implementations visual representation 132/232/332 may be a representation of an average of a plurality of instances of the performance of the same operation, such as a mean, median, or mode of such performances, for example.

According to the exemplary implementation shown in FIG. 3A, visual representation 332 depicts sensor data received from sensors 334a, 334b, 334c, 334d, 334e, 334f, 334g, 334h, 334i 334j, 334k, 334l, 334m, 334n, 334o, 334p, 334q, 334r and 334s (hereinafter “sensors 334a-334s”). It is noted that sensors 334a-334s correspond in general to sensor(s) 134/234 in FIGS. 1 and 2. Consequently, sensors 334a-334s may share any of the characteristics attributed to sensor(s) 134/234 by the present disclosure, and vice versa. It is further noted that the number of sensors represented in FIG. 3A is merely illustrative. In various implementations sensors 334a-334s may include hundreds or thousands of sensors. Also shown in FIG. 3A is expected runtime 337A for the operation depicted in FIG. 3A, as well as time buffer 339 included in visual representation 332 to account for variations in runtimes of the operation depicted in FIG. 3A.

Referring to FIGS. 1, 2 and 3A in combination, according to the implementation depicted in FIG. 3A, data 126/226 is sensor data generated by plurality of digital sensors sensor(s) 134/234/334a-334s during normal operation by apparatus 124/224, and visual representation 332 is a bitmap of that sensor data with respect to time. Thus, visual representation 132/232/332 is generated by software code 110/210 of system 100 or portable device 240 based on data 126/226 generated by sensor(s) 134/234/334a-334s (i.e., sensor data) and depicts the expected operation of apparatus 124/224 when apparatus 124/224 is operating normally.

FIG. 3B shows exemplary visual representation 327, again in the form of a bitmap, of the actual operation of apparatus 124/224 in FIGS. 1 and 2, according to one implementation. It is noted that visual representation 327 is generated by software code 110/210 of system 100 or portable device 240 based on data 126/226 generated by sensor(s) 134/234/334a-334s (i.e., sensor data) and depicts the actual operation by apparatus 124/224 as described by data 126/226. Also shown in FIG. 3B is actual runtime 337B for the operation depicted in FIG. 3B, as well as time buffer 339 included in visual representation 327 to account for variations in runtimes of the operation depicted in FIG. 3B.

It is noted that sensors 334a-334s, in FIG. 3B, are identical to sensors 334a-334s in FIG. 3A, and correspond in general to sensor(s) 134/234 in FIGS. 1 and 2. Thus, visual representation 327 depicts the actual operating state of apparatus 124/224 at a particular time or over a particular period of time. Like visual representation 123/232/332, although visual representation 327 depicts the actual operation of apparatus 124/224, visual representation 327 does not necessarily depict a single operation by apparatus 124/224, but may instead be produced based on an aggregate performance of the same operation a plurality of times by apparatus 124/224. Thus, in some implementations visual representation 327 may correspond to a snapshot of the actual operation by apparatus 124/224 at a particular time. However, in other implementations visual representation 327 may be a representation of an average of a plurality of instances of the performance of the same operation by apparatus 124/224, such as a mean, median, or mode of such performances, for example, over a period of time. Examples of periods of time over which the actual performance of apparatus 124/224 may be averaged include seconds but less than a minute, a minute, minutes but less than an hour, an hour, hours but less than a day, a day, days but less than a week, a week, or weeks.

FIG. 3C shows exemplary visual representation 333 comparing the bitmap shown in FIG. 3B with the bitmap shown in FIG. 3A, according to one implementation. It is noted that any feature in FIG. 3C identified by a reference number identical to one shown in FIG. 3A or 3B corresponds in general to that previously described feature and may share any characteristics attributed to that corresponding feature by the present disclosure.

Referring to FIGS. 3A, 3B and 3C in combination, visual representation 333 reveals several discrepancies in the actual and expected operation (normal operation) of apparatus 124/224. For example, visual representation 333 reveals a variation in data generated by sensor 334m between seconds one and two of the operation, variations in data generated by sensors 334f and 334o between seconds two and three, variations in data generated by sensors 334f, 334j, 334l and 334r between seconds 5 and 6, and by all sensors 334a-334s at the end of the operation depicted by visual representations 327 and 332 due to actual runtime 337B, in FIG. 3B, exceeding expected runtime 337A, in FIG. 3A.

FIG. 3D shows exemplary visual representation 335, in the form of a pixel map, of the operation of apparatus 124/224, according to another implementation. It is noted that any feature in FIG. 3D identified by a reference number identical to one shown in FIG. 3A, 3B or 3C corresponds in general to that previously described feature and may share any characteristics attributed to that corresponding feature by the present disclosure. Visual representation 335 differs from visual representation 327 and 332 in so far as visual representation 335 is produced based on sensor data generated by at least one analog sensor 334t, in addition to sensor data generated by digital sensors 334a-334r. Inclusion of grayscale analog sensor data generated by analog sensor 334t, in visual representation 335, causes visual representation 335 to be produced as a pixel map rather than a pure bitmap.

Although visual representation 335 depicts plurality of digital sensors 334a-334r and single analog sensor 334t, that representation is merely provided by way of example. In various implementations, a visual representation corresponding to visual representation 335 may be produced as a pixel map based on data generated by one or more analog sensors, either alone or in combination with one or more digital sensors. Thus, referring to FIGS. 1, 2 and 3D in combination, in some implementations, data 126/226 may be sensor data generated by a plurality of analog sensors, the visual representation of the actual operation of apparatus 124/224 comprises a pixel map of the sensor data, and the visual representation of the expected operation of apparatus 124/224 comprises a pixel map of the same sensor data generated during a normal operating state of apparatus 124/224. Moreover, analogously to visual representations 332 and 327, visual representation 335 may depict a single instance of an expected or actual operation by apparatus 124/224, or may instead be produced based on an aggregate performance of the same operation a plurality of times by apparatus 124/224.

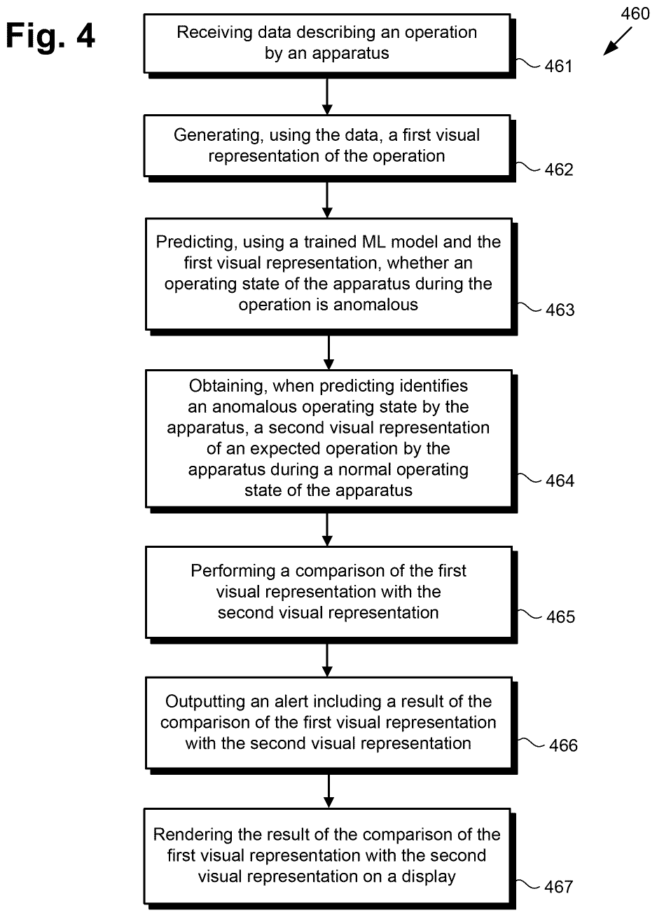

The functionality of system 100 and portable device 140/240 including software code 110/210 and trained ML model(s) 112/212, shown in FIGS. 1 and 2, will be further described by reference to FIG. 4. FIG. 4 shows flowchart 460 presenting an exemplary method providing visualization-based anomaly detection for predictive maintenance, according to one implementation. With respect to the method outlined in FIG. 4, it is noted that certain details and features have been left out of flowchart 460 in order not to obscure the discussion of the inventive features in the present application.

Referring to FIG. 4, with further reference to FIGS. 1 and 2, flowchart 460 includes receiving data 126/226 describing an operation by apparatus 124/224 (action 461). As noted above, in various implementations apparatus 124/224 may be or include a baggage claim carousel, an automated warehouse, a theme park attraction, a vehicle assembly line machine, an aviation system, a HVAC system, an engine, a manufacturing equipment, or a computer server, to name a few examples. The operation by apparatus 124/224 described by data 126/226 may include opening or closing a valve or switch, an acceleration or deceleration of a vehicle, pressurization or depressurization of a container or chamber, or a boot-up sequence by a computer server, to name merely a few examples.

As noted above by reference to data 126, in FIG. 1, in some use cases, data 126/226 may describe a past operation of apparatus 124/224, and may be utilized to perform a forensic analysis of a historical performance of apparatus 124/224. However, in other use cases, data 126/226 may be received dynamically while apparatus 124/224 is in operation and may be used to predict whether apparatus 124/224 is in need of maintenance to correct anomalous operation by apparatus 124/224.

In some implementations, as shown in FIG. 1, data 126 may be received from apparatus sensor(s) 134 via communication network 120 and network communication links 122, in action 461, by software code 110, executed by hardware processor 104 of system 100. In other implementations, as shown by FIG. 2, data 226 may be received from sensor(s) 234 via communication network 220 and network communication links 222, in action 461, by software code 210, executed by hardware processor 244 of portable device 240.

As further noted above, sensor(s) 134/234 may include one or more sensors affixed to apparatus 124/224, internal to apparatus 124/224, or situated adjacent to apparatus 124/224 within a venue housing apparatus 124/224. Moreover, and as also noted above, sensor(s) 134/234 may include one or more cameras, one or more audio microphones, one or more temperature sensors, one or more pressure sensors, one or more vibration sensors, one or more chemical sensors, one or more timing devices, or any combination thereof, and may include one or more digital sensors, one or more analog sensors, or one or more digital sensors and one or more analog sensors.

Referring to FIG. 4 in combination with FIGS. 1, 2 and 3B, flowchart 460 further includes generating, using data 126/226, visual representation 327 (hereinafter first visual representation 327″) of the operation described by data 126/226 (action 462). As noted above, in implementations in which sensor(s) 134/234/334a-334s are digital sensor(s), first visual representation 327 may take the form of a bitmap, as shown in FIG. 3B, depicting the actual operation of apparatus 124/224. However, as shown in FIG. 3D, in implementations in which sensor(s) 134/234/334a-334r/334t include one or more analog sensors, first visual representation 327 may take the form of a pixel map depicting the actual operation of apparatus 124/224, and which corresponds to visual representation 335.

In some implementations, as shown in FIG. 1, first visual representation 327 may be generated, in action 462, by software code 110, executed by hardware processor 104 of system 100. In other implementations, as represented by FIG. 2, first visual representation 327 may be generated, in action 462, by software code 210, executed by hardware processor 244 of portable device 240.

Continuing to refer to FIG. 4 in combination with FIGS. 1, 2 and 3B, flowchart 460 further includes predicting, using trained ML model(s) 112/212 and first visual representation 327, whether the operating state of apparatus 124/224 during the operation depicted by first visual representation 327 is anomalous (action 463). Referring to FIG. 1, in some implementations action 463 may be performed by software code 110, executed by hardware processor 104 of system 100, and using trained ML model(s)112, which receives first visual representation 327 as an input, to provide the prediction regarding anomalous operation. Alternatively, in other implementations, action 463 may be performed by software code 210, executed by hardware processor 244 of portable device 240, and using trained ML model(s) 212 to provide the prediction regarding anomalous operation.

As noted above, in some implementations, trained ML model(s) 112/212 may include one or more U-Nets. The U-Net architecture, originally designed to perform image segmentation, learns rich representations and reconstructs images, making it a good fit for anomaly detection as the reconstruction process enables trained ML model(s) 112/212 to identify deviations from normal patterns. Any such deviations can be predicted to be anomalies.

ML model(s) 112/212 can be developed using the U-Net architecture by training ML model(s) 112/212 on data generated by sensor(s) 134/234/334a-334s when apparatus 124/224 is operating normally. The U-Net model can be trained on a plurality of days of bitmap or pixel map images for a mechanical process while apparatus 124/224 was operating normally. Such a training dataset may include approximately twenty-four hundred (2400) bitmap or pixel map images, for example, partitioned into a training and a validation set. The U-Net model training enables it to learn to segment normal regions of the bitmap or pixel map representation of the mechanical process. At inference time, a new bitmap or pixel map is fed into the model and the model attempts to reconstruct a normal bitmap or pixel map from the new observation. After this reconstruction process, any deviations result in a reconstruction error metric that is greater than 0. The higher the reconstruction error, the more anomalous an operation is considered.

The goal of present anomaly detection solution is to proactively predict anomalous performance far enough in advance for corrective maintenance to be performed without apparatus 124/224 experiencing significant downtime. According to one approach, a full day's worth of reconstruction errors are combined into a distribution. That distribution can be compared to a distribution of reconstruction errors when apparatus 124/224 is behaving normally. If the most recent distribution of reconstruction errors is different enough based on a distance metric, such as the Wasserstein Distance for example, from the distribution of reconstruction errors during normal mechanical operation, then an alert is output, as described below.

In implementations in which the predicting performed in action 463 fails to detect an anomalous operating state by apparatus 124/224, the method outlined by flowchart 460 may conclude with action 463. However, referring to FIG. 4 in combination with FIGS. 1, 2 and 3A, in some implementations, flowchart 460 may further include obtaining, when the predicting performed in action 463 identifies an anomalous operating state by apparatus 124/224, visual representation 132/232/332 (hereinafter “second visual representation 132/232/332”) of the expected operation by apparatus 124/224 during a normal operating state of apparatus 124/224 (action 464). As noted above, in implementations in which sensor(s) 134/234/334a-334s are digital sensor(s), second visual representation 132/232/332 may take the form of a bitmap, as shown in FIG. 3A, depicting the expected operation of apparatus 124/224. However, as shown in FIG. 3D, in implementations in which sensor(s) 134/234/334a-334r/334t include one or more analog sensors, second visual representation 132/232/332 may take the form of a pixel map depicting the expected operation of apparatus 124/224, and which corresponds to visual representation 335.

In some implementations, as shown in FIG. 1, second visual representation 132/332 may be obtained from apparatus expected operational state database 130 via communication network 120 and network communication links 122, in action 464, by software code 110, executed by hardware processor 104 of system 100. In other implementations, as shown by FIG. 2, second visual representation 232/332 may be obtained from apparatus expected operational state database 230 via communication network 220 and network communication links 222, in action 464, by software code 210, executed by hardware processor 244 of portable device 240.

Referring to FIG. 4 in combination with FIGS. 1, 2, 3A, and 3B, flowchart 460 may further includes performing a comparison of first visual representation 327 with second visual representation 132/232/332 (action 465). In some implementations, for example performing the comparison in action 465 may include overlaying first visual representation 327 on second visual representation 132/232/332. Alternatively, or in addition, in some implementations performing the comparison in action 465 may include overlaying second visual representation 132/232/332 on first visual representation 327. In some implementations, action 465 may be performed by software code 110, executed by hardware processor 104 of system 100. However, in other implementations action 465 may be performed by software code 210, executed by hardware processor 244 of portable device 240.

Referring to FIG. 4 in combination with FIGS. 1, 2, 3A, 3B, and 3C, flowchart 460 may further include, outputting alert 142/242 including the result of the comparison of first visual representation 327 with second visual representation 132/232/332 depicted by visual representation 333 (action 466). Thus, the result of the comparison of first visual representation 327 with second visual representation 132/232/332 may be visual representation 333 in which first visual representation 327 is overlaid on second visual representation 132/232/332 and/or second visual representation 132/232/332 is overlaid on first visual representation 327. In some implementations, as shown in FIG. 1, outputting alert 142 including visual representation 333 as the result of the comparison of first visual representation 327 with second visual representation 132/232/332, in action 466, may include transmitting, by system 100, alert 142 to portable device 140 via communication network 120 and network communication links 122. In those implementations, action 466 may be performed by software code 110, executed by hardware processor 104 of system 100.

However, in other implementations, as shown in FIG. 2, outputting alert 242 including visual representation 333, in action 466 may include outputting alert 242 including visual representation 333 to display 250 of portable device 240. In implementations in which action 466 includes outputting alert 242 to display 250, action 466 may be performed by software code 210, executed by hardware processor 244 of portable device 240.

Whether action 466 is performed by system 100 or portable device 140/240, in some implementations, alert 142/242 including visual representation 333 may be output in real-time with respect to receiving data 126/226 in action 461. It is noted that, as defined for the purposes of the present application, the expression “real-time” refers to latency of a few seconds, such as up to ten seconds, or less. Thus, in some implementations, alert 142/242 including visual representation 333 may be provided to system user 138, in action 466, within ten seconds or less of receipt of data 126/226 by system 100 or portable device 140/240 in action 461. Moreover, in some implementations, alert 142/242 may be stored in a database, either prior to being output in action 466, subsequent to being output in action 466, or in parallel with, i.e., stored contemporaneously with being output in action 466.

It is further noted that one advantage of generating visual representation 327 of the actual performance of apparatus 124/224 based on an average or other type of aggregate performance by apparatus 124/224 over a period of time is the reduction or avoidance of false positives alerts output in response to a transient anomaly.

In some implementations, as noted above, the method outlined by flowchart 460 may conclude with action 463, described above, while in other implementations the method outlined by flowchart 460 may conclude with action 466, also described above. However, and referring to FIGS. 2, 3C and 4 in combination, in other implementations, flowchart 460 may further include rendering the comparison of the visual representation 327 with second visual representation 232/332 depicted by visual representation 333 on display 250 of portable device 240 (action 467). In implementations in which the method outlined by flowchart 460 includes action 467, the rendering of visual representation 333 on display 250 may be performed by software code 210, executed by hardware processor 244 of portable device 240.

With respect to the method outlined by FIG. 4, it is emphasized that actions 461, 462 and 463 (hereinafter “actions 461-463”), or actions 461-463, 464, 465 and 466 (hereinafter “actions 461-466”), or actions 461-466 and 467, may be performed in an automated process from which human involvement may be omitted. Furthermore, in addition to actions 461-463, actions 461-466, or actions 461-466 and 467, in some implementations, hardware processor 104 of system 100 may further execute software code 110, or hardware processor 244 of portable device 140/240 may further execute software code 210, to perform an intervention when the predicting performed in action 463 identifies an anomalous operating state by apparatus 124/224. Such an intervention may include one or more of sounding an alarm at apparatus 124/224 by system 100 or portable device 140/240, shutting down operation of apparatus 124/224 by system 100 or portable device 140/240, or modifying the performance of apparatus 124/224, to name a few examples.

Thus, the present application discloses systems and methods providing visualization-based anomaly detection for predictive maintenance that address and overcome the drawbacks and deficiencies in the conventional art by enabling system engineers of varying degrees of experience to readily diagnose the operational states of complex apparatuses, and to accurately anticipate situations in which those system are likely to malfunction or fail. The present solution recognizes that even complex apparatuses are designed to follow an expected operating pattern that is programmed. Sensors may be outfitted on, in, or adjacent to apparatus components that allow for these operating patterns to be tracked through data. The present visualization-based anomaly detection for predictive maintenance solution advances the state-of-the-art by converting sensor readings or other data describing an operation by an apparatus into a visual representation of that operation, such as a bitmap image or pixel map image, for example. This novel and inventive transformation of the data advantageously enables use of one or more sophisticated visualization-based ML models to trained to predict whether the apparatus is operating normally or in an anomalous operating state indicative of malfunction, future apparatus failure, or both.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a hardware processor; and
a memory storing a software code and a trained machine learning (ML) model;
the hardware processor configured to execute the software code to:
receive data describing an operation by an apparatus;
generate, using the data, a first visual representation of the operation;
predict, using the trained ML and the first visual representation of the operation, whether an operating state of the apparatus during the operation is anomalous;
obtain, when predicting identifies an anomalous operating state by the apparatus, a second visual representation of an expected operation by the apparatus during a normal operating state of the apparatus;
perform a comparison of the first visual representation with the second visual representation; and
output an alert including a result of the comparison of the first visual representation with the second visual representation.

2. The system of claim 1, wherein the data is received dynamically while the apparatus is in operation.

3. The system of claim 1, wherein the data is sensor data generated by at least one digital sensor, wherein the first visual representation comprises a first bitmap of the sensor data, and wherein the second visual representation comprises a second bitmap of expected sensor data generated by the at least one digital sensor during the normal operating state of the apparatus.

4. The system of claim 1, wherein the data is sensor data generated by at least one analog sensor, wherein the first visual representation comprises a first pixel map of the sensor data, and wherein the second visual representation comprises a second pixel map of expected sensor data generated by the at least one analog sensor during the normal operating state of the apparatus.

5. The system of claim 1, wherein the result of the comparison of the first visual representation with the second visual representation comprises a visual representation in which (i) the first visual representation is overlaid on the second visual representation, or (ii) the second visual representation is overlaid on the first visual representation.

6. The system of claim 1, further comprising:
a display;
wherein the hardware processor is further configured to execute the software code to:
render the result of the comparison of the first visual representation with the second visual representation on the display.

7. The system of claim 1, wherein the apparatus comprises one of a baggage claim carousel, an automated warehouse, a theme park attraction, a vehicle assembly line machine, an aviation system, a HVAC system, an engine, a manufacturing equipment, or a computer server.

8. The system of claim 1, wherein the hardware processor is further configured to execute the software code to:
when predicting identifies the anomalous operating state by the apparatus, perform at least one of (i) sounding an alarm at the apparatus, (ii) shutting down operation of the apparatus, or (iii) modifying a performance of the apparatus.

9. A method for use by a system including a hardware processor and a memory storing a software code and a trained machine learning (ML) model, the method comprising:
receiving, by the software code executed by the hardware processor, data describing an operation by an apparatus;
generating, by the software code executed by the hardware processor and using the data, a first visual representation of the operation;
predicting, by the software code executed by the hardware processor and using the trained ML model and the first visual representation of the operation, whether an operating state of the apparatus during the operation is anomalous;
obtaining, by the software code executed by the hardware processor when predicting identifies an anomalous operating state by the apparatus, a second visual representation of an expected operation by the apparatus during a normal operating state of the apparatus;
performing, by the software code executed by the hardware processor, a comparison of the first visual representation with the second visual representation; and
outputting, by the software code executed by the hardware processor, an alert including a result of the comparison of the first visual representation with the second visual representation.

10. The method of claim 9, wherein the data is received dynamically while the apparatus is in operation.

11. The method of claim 9, wherein the data is sensor data generated by at least one digital sensor, wherein the first visual representation comprises a first bitmap of the sensor data, and wherein the second visual representation comprises a second bitmap of expected sensor data generated by the at least one digital sensor during the normal operating state of the apparatus.

12. The method of claim 9, wherein the data is sensor data generated by at least one analog sensor, wherein the first visual representation comprises a first pixel map of the sensor data, and wherein the second visual representation comprises a second pixel map of expected sensor data generated by the at least one analog sensor during the normal operating state of the apparatus.

13. The method of claim 9, wherein performing the comparison of the first visual representation with the second visual representation comprises (i) overlaying the first visual representation on the second visual representation, or (ii) overlaying the second visual representation on the first visual representation.

14. The method of claim 9, further comprising:
rendering, by the software code executed by the hardware processor, the result of the comparison of the first visual representation with the second visual representation on a display.

15. The method of claim 9, wherein the apparatus comprises one of a baggage claim carousel, an automated warehouse, a theme park attraction, a vehicle assembly line machine, an aviation system, a HVAC system, an engine, a manufacturing equipment, or a computer server.

16. The method of claim 9, further comprising:
performing, by the software code executed by the hardware processor when predicting identifies the anomalous operating state by the apparatus, at least one of (i) sounding an alarm at the apparatus, (ii) shutting down operation of the apparatus, or (iii) modifying a performance of the apparatus.

17. A computer-readable non-transitory medium having stored thereon instructions and a trained machine learning (ML) model, which when executed by a hardware processor, instantiate a method comprising:
receiving data describing an operation by an apparatus;
generating, using the data, a first visual representation of the operation;
predicting, using the trained ML model and the first visual representation of the operation, whether an operating state of the apparatus during the operation is anomalous;
obtaining, when predicting identifies an anomalous operating state by the apparatus, a second visual representation of an expected operation by the apparatus during a normal operating state of the apparatus;
performing a comparison of the first visual representation with the second visual representation; and
outputting an alert including the comparison of the first visual representation with the second visual representation.

18. The computer-readable non-transitory medium of claim 17, wherein:
the data is sensor data generated by at least one digital sensor, the first visual representation comprises a first bitmap of the sensor data, and the second visual representation comprises a second bitmap of expected sensor data generated by the at least one digital sensor during the normal operating state of the apparatus; or
the data is sensor data generated by at least one analog sensor, the first visual representation comprises a first pixel map of the sensor data, and the second visual representation comprises a second pixel map of expected sensor data generated by the at least one analog sensor during the normal operating state of the apparatus.

19. The computer-readable non-transitory medium of claim 17, wherein performing the comparison of the first visual representation with the second visual representation comprises (i) overlaying the first visual representation on the second visual representation, or (ii) overlaying the second visual representation on the first visual representation.

20. The computer-readable non-transitory medium of claim 17, the method further comprising:
performing, when predicting identifies the anomalous operating state by the apparatus, at least one of (i) sounding an alarm at the apparatus, (ii) shutting down operation of the apparatus, or (iii) modifying a performance of the apparatus.
